(19) United States
(12) Patent Application Publication
(10) Pub. No.: US 2010/0032248 A1
(43) Pub. Date: Feb. 11, 2010

(54) ELEVATOR DAMPER ASSEMBLY

(75) Inventors: Yisug Kwon, Farmington, CT (US); Randall K. Roberts, Hebron, CT (US)

Correspondence Address: CARLSON GASKEY & OLDS, 400 W MAPLE STE 350, BIRMINGHAM, MI, 48009, US

(73) Assignee: OTIS ELEVATOR COMPANY, Farmington, CT (US)

(21) Appl. No.: 12/513,908

(22) PCT Filed: Dec. 20, 2006
(86) PCT No.: PCT/US2006/062354

§ 371 Date: May 7, 2009

(51) Int. Cl. B66B 7/00

(52) U.S. Cl. 187/414

(57) ABSTRACT

A damper assembly (22) is useful for controlling elevator ride quality. The damper assembly (22) includes a resilient member that deflects responsive to a load. An effective stiffness of the resilient member is less than an associated rate of deflection of the resilient member. The resilient member includes a first portion (30, 40) that deflects prior to a second portion (32, 42) responsive to an initial loading on the damper assembly (22).

### BACKGROUND

Elevator systems include a variety of features to enhance the ride quality. One such feature is a vibration isolator or damper arrangement provided between an elevator cab and an associated elevator car frame. The vibration isolator arrangement is intended to minimize the transmission of vibrations from the car frame to the cab. That way, passengers within the cab experience a smoother ride. Additionally, vibration isolators arc intended to minimize the amount of noise transmission into an elevator cab to provide a quieter ride.

One of the drawbacks associated with conventional arrangements is that vibration isolators including elastomeric, natural rubber or metal spring components are constrained by system level static loads and maximum deformation requirements. Such constraints render conventional isolators stiffer than is otherwise desirable. Higher stiffness reduces the ability of an isolator to reduce noise and vibration.

Additionally, many vibration isolators become overly compressed during the installation of an elevator system. It is typically necessary to level an elevator cab by adjusting its position relative to the frame during installation. It is not uncommon for the vibration isolators to be used for correcting an undesired tilt of the elevator cab. Such a technique compresses the vibration isolators in a manner that dramatically reduces the ability to reduce noise and vibration transmission into the cab.

### SUMMARY

An exemplary elevator damper assembly includes a resilient member that is configured to be deflected in response to a load such that an effective stiffness of the resilient member is less than an associated deflection rate of the resilient member at least between an undeflected condition and an initial deflection of the resilient member.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIGS. 2A-2C illustrate one example damper assembly embodiment in different loading conditions.

FIG. 3 schematically illustrates another example damper assembly.

FIGS. 4A-4C schematically illustrate another example damper assembly embodiment under different loading conditions.

FIG. 5 is a graphical illustration of a relationship between stiffness and deflection.

FIG. 6 schematically illustrates a conventional vibration damper.

FIG. 7 graphically illustrates a relationship between transmissibility of noise and a frequency response of an example elevator damper assembly.

### DETAILED DESCRIPTION

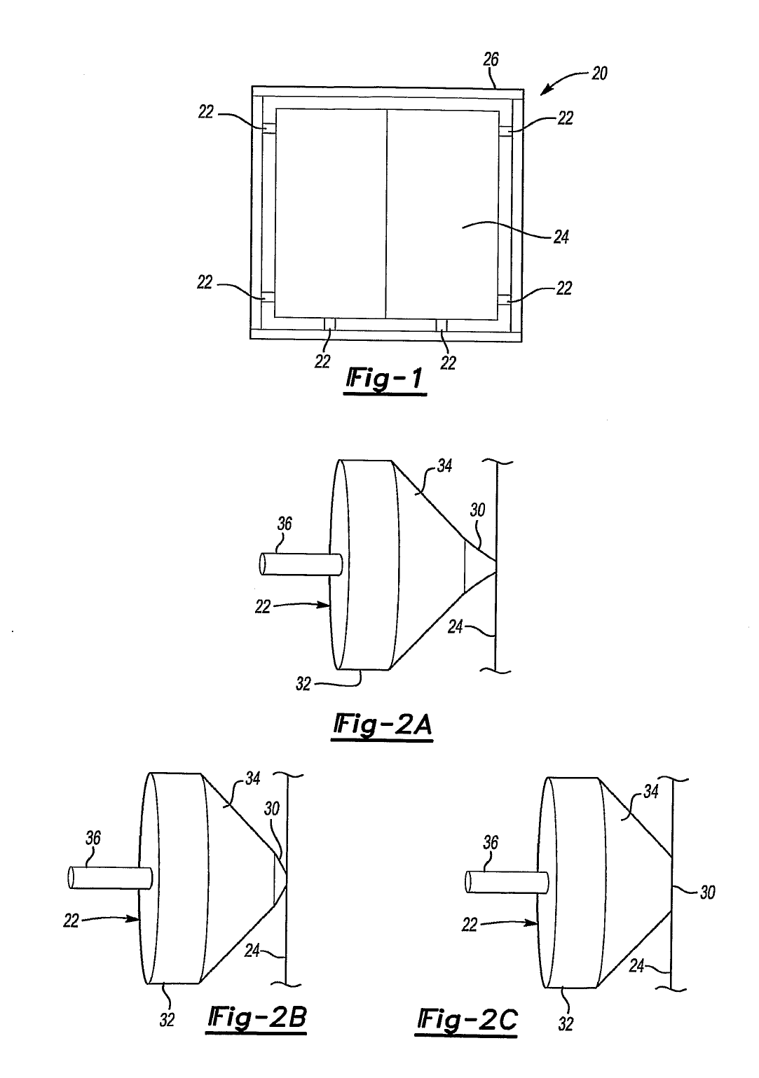

FIG. 1 schematically shows selected portions of an elevator system 20. In this example, a plurality of damper assemblies 22 are situated between an elevator cab 24 and an associated frame 26 that supports the cab 24 and allows it to be moved within a hoistway in a known manner. The damper assemblies 22 provide vibration isolation so that individuals within the cab 24 will not experience vibration experienced by the frame 26. The damper assemblies 22 also provide structural borne noise isolation resulting from vibration of the frame 26, operation of an elevator machine or from the surrounding environment of the cab 24.

The damper assemblies 22 include a resilient member that deflects responsive to a load associated with relative movement between the cab 24 and the frame 26. The damper assemblies 22 are intended to isolate the cab 24 from vibration that would otherwise be transmitted to the cab 24 if there were a rigid connection between the frame 26 and the cab 24.

FIG. 2A shows one example damper assembly 22. The resilient member in this example includes a first portion 30 having a first, nominal outside dimension. A second portion 32 of the body of the resilient member has a second, larger outside dimension. In this example, a partially conical portion 34 has an outside dimension that varies from approximately the first outside dimension of the first portion 30 to approximately the second outside dimension of the second portion 32.

In one example, the first portion 30 comprises a different material than that used for the second portion 32. One example includes ethylene polypropylene diene monomer (EPDM) for the first portion 30 and a relatively harder rubber material for the second portion 32. Depending on the selected materials, the geometry of the resilient member may be varied to achieve a desired response.

In one example, the first portion 30 has a length along an axis of the damper assembly 22 that is approximately ⅓ the overall length of the resilient member.

The example of FIG. 2A includes a mounting portion 36 that is adapted to be secured in a fixed position relative to one of the frame 26 or the cab 24. In the illustrated example, the mounting portion 36 is secured to a suitably arranged portion associated with the frame 26 and the first portion 30 faces the cab 24.

The different dimensions of the different portions 30, 32 of the resilient member provide a different effective stiffness of the damper assembly 22 responsive to different loads or different amounts of deflection of the damper assembly 22. The smaller outside dimension and cross-sectional area of the first portion 30 provides a lower stiffness responsive to a load that begins to cause deflection of the resilient member of the damper assembly 22. As the load increases and the resilient member deflects further, the larger outside dimension and cross-sectional area of the second portion 32 results in an increased stiffness, which increases at a greater rate as there is further deflection of the resilient member body.

For example, FIG. 2A shows the illustrated example in a non-deflected, non-loaded condition. FIG. 2B shows another condition where the damper assembly 22 is subject to some load. In this condition, the first portion 30 has been deformed or deflected responsive to the load. The smaller outside dimension of the first portion 30 compared to the second portion 32 contributes to the first portion 30 deflecting or deforming before any deflection or deformation of the second portion 32. In one example, the first portion 30 comprises a softer material than that used for the second portion 32, which contributes additionally to the initial deformation of the first portion 30.

FIG. 2C shows the same embodiment subject to a greater load than that represented by FIG. 2B. At this point, the first portion 30 has become compressed and deflected such that it is no longer visible from the perspective of FIG. 2C. Any further load on the damper assembly 22 causes compression and deflection of the remainder of the resilient member and eventually the second portion 32.

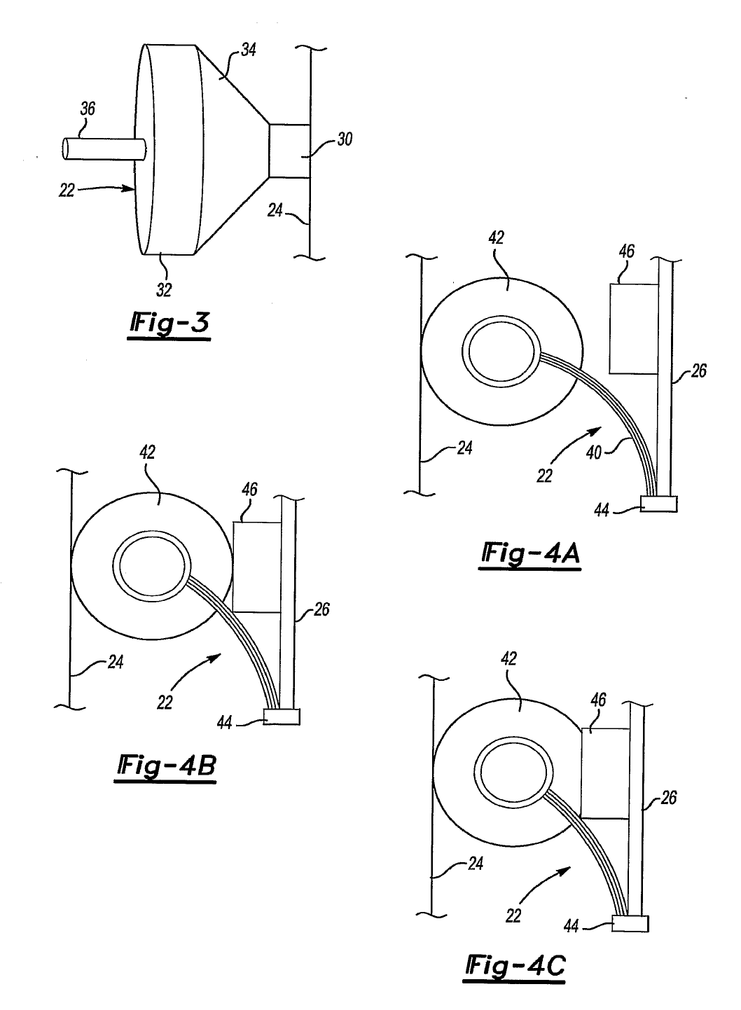

In the example of FIGS. 2A-2C, the first portion 30 has a tapered profile. In one example, the first portion 30 is frustroconical. FIG. 3 shows another example embodiment where the first portion 30 is generally cylindrical. In this example, the first portion 30 behaves much like that in the example of FIGS. 2A-2C in that it becomes compressed and deflected before the second portion 32 deflects responsive to an initial loading from an uncompressed, unloaded state.

In one example, the first portion 30 is visibly distinct from the second portion 32 such that a visual inspection of the damper assembly 22 provides information to a technician regarding the current loading condition on the damper assembly 22. By seeing how much of the first portion is visible (i.e., not deflected responsive to load), a technician can readily, visually inspect the condition of the damper assembly and make any adjustments that may be necessary for maintaining a desired level of noise and vibration isolation. In one example, different materials are chosen for the first portion 30 and the second portion 32 so that the materials are visibly distinct from each other. In some examples, the different materials will be selected for different hardness levels, different visual characteristics or both.

FIG. 4A schematically shows another example damper assembly 22 that minimizes the vertical direction friction force, which is useful for a load weighing system that measures passengers' weight on the cab 24. The resilient member in this example comprises a flexible arm 40. In one example, the flexible arm 40 comprises a leaf spring. One end of the flexible arm 40 supports a roller 42 while an opposite end 44 is secured in a fixed position relative to an appropriate portion of the frame 26. In this example, the roller 42 is positioned against the cab 24 in an unloaded, non-deflected state as shown in FIG. 4A. The roller 42 minimizes vertical direction function forces.

In one example, the flexible arm 40 comprises a metal leaf spring. The roller 42 comprises an elastomeric material such as rubber that is stiffer than the stiffness of the flexible arm 40.

FIG. 4B shows the damper assembly 22 of FIG. 4A subject to some load. Under this condition, the flexible arm 40 has deflected such that the roller 42 comes into contact with a stop member 46 that is supported in a fixed position on a corresponding portion of the frame 26. The stop member 46 in one example comprises a hard rubber that is stiffer than the elastomeric material of the roller 42. In one example, the roller 42 is a distinct color from the stop member 46 to facilitate visual inspection of such an embodiment. In the example of FIG. 4B, the flexible arm 40 has deflected but the roller 42 has not.

FIG. 4C shows a further loaded condition compared to FIG. 4B. In this condition, the roller 42 has become partially compressed or deflected responsive to additional load compared to that represented by FIG. 4B. The example roller 42 comprises a resilient material so that it becomes deflected or compressed responsive to sufficient load as the frame 26 and cab 24 move closer together at the location of the roller 42.

One aspect of each of the example damper assemblies 22 is that the effective stiffness of the damper assembly increases at a rate that is slower than a rate of deflection or compression of the resilient member of the damper assembly 22. In one example, the stiffness changes at a rate that is less than an associated rate of deflection of the resilient member in a direction that is generally parallel to a direction of force applied to the resilient member.

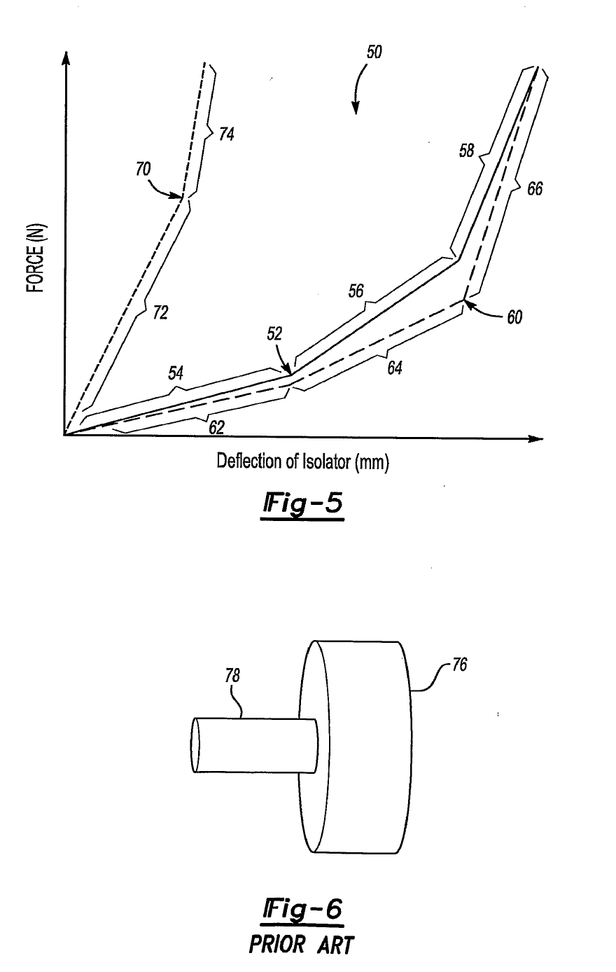

FIG. 5 includes a graphical plot 50 of a relationship of the force on the damper to its deflection. One example curve 52 shows the relationship between force and deflection for a damper assembly as shown in FIGS. 2A-2C, for example. A portion 54 of the curve 52 corresponds to the relationship of the change in force relative to the amount of deflection of the resilient member of the damper assembly 22 from an unloaded condition (at the origin of the graph) up to an initial, intermediate load and associated deflection. The portion 54 corresponds to, for example, the change in deflection of the resilient member schematically represented by the change between FIGS. 2A and 2B.

Another portion of the curve 52 represented at 56 corresponds to an increasing load on the resilient member resulting in farther deflection. The portion 56 of the curve 52 in one example corresponds to a change in deflection of the resilient member represented by the change from FIG. 2B to FIG. 2C. As can be appreciated from the illustration, the portion of the curve 56 has an average slope that is greater than the average slope of the portion 54. That is, the effective stiffness of the damper is higher in the operating range of deflections represented in the portion 56 relative to the operating range of deflections represented in the portion 54. FIG. 5 also demonstrates how such an example includes a change in the amount of deflection that occurs at a higher rate than a change in stiffness of the damper assembly 22 at least under some initial loading conditions.

Another portion 58 of the curve 52 corresponds to further compression and deflection of the resilient member responsive to an increasing load. In one example, this corresponds to deflection of the second portion 32 of the resilient member. Relatively higher loading results in a larger effective stiffness as the first portion 30 is completely deflected and the second portion 32 begins to deflect. As can be appreciated from FIG. 5, providing a first portion 30 having a smaller outside dimension than a second portion 32 provides a varying effective stiffness of the damper assembly. The effective stiffness is less than a corresponding change in deflection of the resilient member until the second portion 32 begins to deflect. At that point the effective stiffness is larger.

Another curve 60 schematically represents a relationship between force and deflection for an embodiment as shown in FIGS. 4A-4C. The portion of the curve 62 corresponds to a change between the conditions represented by FIGS. 4A and 4B, for example. The portion 64 corresponds to the change in force occurring from the condition of FIG. 4B to that schematically shown in FIG. 4C. The portion of the curve 66 corresponds to further loading and additionally increased stiffness associated with compression of the roller 42 between the cab 24 and the stop member 46, for example. As can be appreciated from FIG. 5, using a flexible arm 40 having a lower stiffness than a stiffness of a resilient roller 42 provides a varying effective stiffness that increases as a function of increasing load on the damper assembly.

FIG. 5 demonstrates how a damper assembly designed according to an embodiment of this invention provides an improved response to changing loads compared to conventional vibration isolators. The curve 70 in FIG. 5 represents a typical relationship between force and deflection for a conventional vibration isolator of a type shown in FIG. 6.

The conventional vibration isolator has a resilient member 76 and a mounting portion 78. The resilient member 76 has a constant cross-sectional area and is made of a relatively hard resilient material such that very little deflection is possible. A first portion 72 of the curve 70 shows how the effective stiffness is less than another portion 74 of the curve 70 where the loading is increased. The vibration isolator is so stiff that it loses any ability to isolate a cab from vibrations and noise transmitted to the cab through the frame 26. The relatively hard resilient material of the resilient member 76 allows almost none or very little deflection and results in the relationship between applied force and deflection schematically represented by the curve 70.

In comparison to the conventional vibration isolator shown in FIG. 6, the decreased effective stiffness associated with the curves 52 and 60 provides for enhanced damping of noise and vibration and enhanced elevator ride quality. The slopes of the portions of the curves shown at 54, 56, 62 and 64 are all significantly lower than the slope of the portion 72. The larger sized second portion 32 provides adequate stiffness to satisfy elevator system loading requirements while the first portion 30 provides lower stiffness to enhance ride quality.

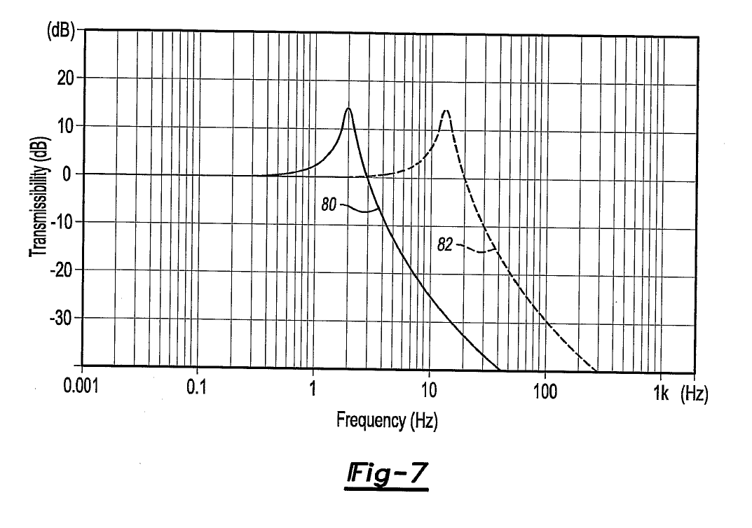

FIG. 7 graphically represents a frequency response indicating vibration transmissibility into an elevator cab 24. A first curve 80 corresponds to a frequency response and transmissibility associated with an example embodiment of a damper assembly 22. By comparing this response to that of the conventional arrangement shown by the curve in phantom at 82, it is noticeable that a much lower vibration transmissibility occurs with a damper assembly 22 designed according to an embodiment of this invention. The varying stiffness, including an effective stiffness that is less than an associated rate of deflection, allows for an increased capability of preventing vibration transmissions into an elevator cab.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. An elevator damper assembly, comprising:
a resilient member that is configured to deflect responsive to a load, wherein as the resilient member is deflected by the load, a change in an amount of deflection of the resilient member occurs at a higher rate than a change in an effective stiffness of the resilient member at least between an undeflected condition and an initial deflection amount.

2. The assembly of claim 1, wherein the resilient member comprises:
a first portion having a first, nominal outside dimension; and
a second portion having a second, larger outside dimension.

3. The assembly of claim 2, wherein the first portion is near one end and the second portion is near a second end of the body.

4. The assembly of claim 2, wherein the body has an at least partially conical profile.

5. The assembly of claim 4, wherein the at least partially conical profile is between the first and second portions.

6. The assembly of claim 4, wherein the first portion has the conical profile.

7. The assembly of claim 2, wherein the first portion is visibly distinct from the second portion.

8. The assembly of claim 2, where in the first portion comprises a first material and the second portion comprises a second, different material.

9. The assembly of claim 8, wherein the first portion comprises ethylene polypropylene diene monomer (EPDM) and the second portion comprises an elastomer that is relatively harder than EPDM.

10. The assembly of claim 2, wherein compression of the first portion provides a visible indication of load on the resilient member.

11. The assembly of claim 1, wherein a ratio of effective stiffness to the associated rate of deflection of the resilient member varies with an amount of force applied to the resilient member.

12. The assembly of claim 11,
wherein the ratio has a first value up to a first deflection amount that is less than the initial deflection amount, and
wherein the ratio has a second, higher value between the first deflection amount and the initial deflection amount.

13. The assembly of claim 1, wherein the resilient member comprises:
a flexible arm having a first stiffness; and
a resilient body near a first end of the flexible arm, the resilient body having a second, greater stiffness.

14. The assembly of claim 13, wherein the flexible arm comprises a leaf spring.

15. The assembly of claim 13, wherein the resilient body comprises a roller.

16. The assembly of claim 13, wherein the flexible arm and the resilient body are arranged so that the flexible arm is configured to deflect responsive to a first load and the resilient body is configured to deflect responsive to a second, greater load on the damper assembly.

17. The assembly of claim 13,
wherein the flexible arm has a second end fixed in one position, and
wherein the resilient body is configured to move, as the flexible arm deflects, between a first position in which the arm has no contact with a stopper spaced lIomn first position and a second position in which the resilient body contacts the stopper.

18. The assembly of claim 17,
wherein the resilient body is configured to move into the second position to contact the stopper responsive to a first load, and
wherein the resilient body is configured to deflect against the stopper responsive to an increasing load that is greater than the first load.

19. The assembly of claim 17, wherein the resilient body comprises a first material and the stopper comprises a second, harder material.

20. An elevator apparatus comprising:
an elevator cab;
a frame associated with the elevator cab; and
a resilient member that is configured to deflect responsive to a load such that a stiffness of the resilient member increases at a rate that is less than an associated deflection rate of the resilient member at least between an undeflected condition and an initial deflection amount,
wherein the resilient member is positioned between the elevator cab and the frame.
